(19) United States
(12) Patent Application Publication
(10) Pub. No.: US 2003/0168386 A1
(43) Pub. Date: Sep. 11, 2003

(54) Sea sand desalination method

(76) Inventor: Hung-Yuan Lee, Changhua Hsien (TW)

Correspondence Address: RABIN & BERDO, P.C., Suite 500, 1101 14th Street, N.W., Washington, DC, 20005, US

(21) Appl. No.: 10/093,065

(22) Filed: Mar. 8, 2002

(51) Int. Cl. B07B 9/00

(52) U.S. Cl. 209/234

(57) ABSTRACT

A sea sand desalination method includes: pumping sea sand to a first fresh water wash and a vibration sifter at the same time to purge foreign matter, salt, and coarse grains; blending in measuring tank at a sea sand-water ratio of 0.6:1; pouring the mixture into a heating tank and heating to boiling point; and sending it to a filtration machine for straining. The filtration machine filters the sea sand with hot water at its front section and a second fresh water wash at its rear section, and then discharges the hot water. The sea sand in the filtration machine is thereafter conveyed into a second vibration sifter and a third fresh water wash for purging. The post-wash fresh water after above-mentioned wash flows into a first and second waste water pool, respectively. Finally, the fully depurated sea sand is conveyed via a water wheel to a sand dumping site.

### BACKGROUND OF THE INVENTION

1) Field of the Invention

The invention herein relates to a sea sand desalination method, specifically a method that flushes salt from sea sand and provides for its suitability as a civil engineering- and construction-use fine aggregate that meets the salt content requirements of such materials.

2) Description of the Related Art

The sand (fine aggregate) utilized in concrete is conventionally extracted from river beds and dry land. However, since the current production capacity of such sandstone resources is inadequate, prices have gradually become more expensive and large-scale construction projects have experienced major delays. Since river sand dredging affects bridge safety, river sand resources have gradually dwindled and, furthermore, with the heavy public resistance against land sand excavation, sea sand has become a potential resource capable of supplying fine aggregate material for domestic civil engineering and construction usage.

However, when sea sand is actually utilized, the first problem encountered is the salt contained in the sea sand. If such salt is not treated and the sea sand is directly utilized for civil engineering and construction concrete projects, concrete structural durability may be affected and result in concrete swelling, precipitation, sulfating, steel reinforcement rod corrosion, and other adverse consequences. Therefore, the salt content of the sea sand must be eliminated before it is utilized to avoid the potential hazards. Although sea sand is not utilized domestically in large volume at present, small quantities of unlawfully excavated sea sand and channel dredged sea sand without appropriate desalination quality control have entered the market that may unfortunately result in various hidden construction and engineering quality hazards. In view of the existent problems, it is expected that sea sand utilization potential will require the development of an economical, rapid, and consistent method of desalination to enable sea sand to become a certified and reliably usable resource that is depended on by society and the general public.

In the conventional technology, when sea sand is desalinated, the desalting method includes immersion, natural sunlight exposure, rinsing, and mechanical methods, with rinsing, immersion, and mechanical processes being the most common. Since the domestic technology is still in the initial stage, testing and research has only been conducted on the immersion method. In view of the fact that sea sand utilization is a future trend, research into a rapid, economical, high quality, and reliable desalination method is definitely necessary.

### SUMMARY OF THE INVENTION

The primary objective of the invention herein is to utilize the sea sand desalted through the cleansing and heating processes of the present invention for fine aggregate in concrete that meets CNS1240 (concrete aggregate) standards and, furthermore, has a harmful substance presence in which the maximum allowable water-soluble chlorine ion content is lower than levels defined by the said standards (CNS1240 stipulates <0.012% for prestressed concrete and <0.024% for other types of concrete, but the invention herein is capable of achieving levels of 0.003%.), with the resulting sea sand (fine aggregate) suitable as an additive in coarse aggregate, water, and cement concrete mixtures such that abundant sea sand resources can be fully utilized and, furthermore, with ensured sea sand concrete safety, while providing a solution for dry land and river sandstone insufficiency problems.

Therefore, the procedures of the invention herein involve pumping sea sand to both a first fresh water wash and a vibration sifter at the same time to purge foreign matter, salt, and coarse grains; blending in measuring tank at a sea sand-water ratio of 0.6:1; pouring into a heating tank and heating to boiling point for several minutes; and sending via a rolling barrel-type screw conveyor at the completion of heating to a filtration machine for straining. The said filtration machine filters the sea sand with hot water at its front section and a second fresh water wash at its rear section, and then discharges the hot water and the post-wash fresh water into a first waste water pool. The sea sand in the filtration machine is thereafter conveyed into a second vibration sifter and a third fresh water wash for purging, following which the post-wash fresh water flows into a second waste water pool The water in the said pool is then pumped to the first fresh water wash for recycling and re-use, and the fully depurated sea sand is conveyed via a water wheel to a sand dumping site, thereby completing the sea sand desalination method of the present invention.

To enable a further understand of the procedures of the present invention, the brief description of the drawings below is followed by the detailed description of the invention herein.

### BRIEF DESCRIPTION OF THE DRAWINGS

FIG. 1 is a flowchart of the sea sand desalination method of the invention herein.

### DETAILED DESCRIPTION OF THE INVENTION

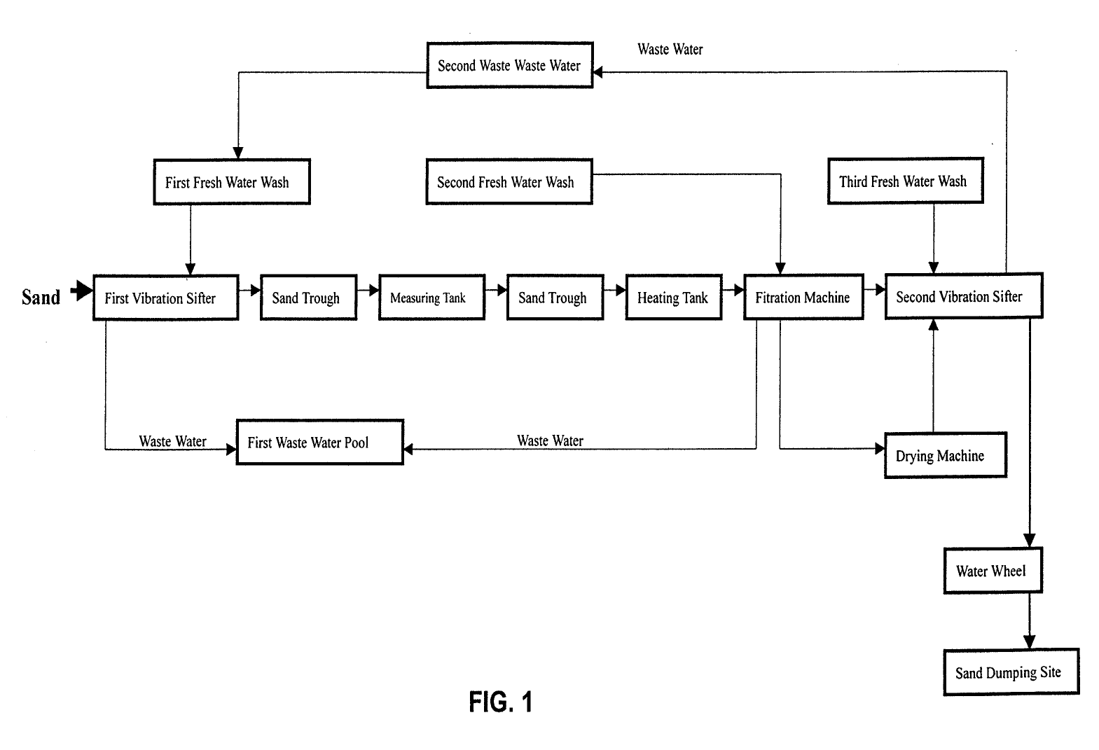

Referring to FIG. 1, the desalination process of the invention herein, the method herein consists of the following procedures: in Step A, drawn sea sand is conveyed into a first vibration-type sifter machine 1 (referred to hereafter as vibration sifter) and a first fresh water wash S1 to purge coarse grains and foreign matter in the sea sand, with the post-wash waste water then flowing to a first waste water pool 9, and the coarse grains and foreign matter are discharged through pipes such that the resultant depurated sea sand is conveyed into a first sand trough 2, at which time the sea sand has undergone the first phase of depuration and the salt content at the surface of the sea sand is partially eliminated to thereby reduce overall salinity; in Step B, a fixed quantity of sea sand in the first sand trough 2 is conveyed into a large measuring tank 3, with the sea sand in the measuring tank 3 blended with water at an approximate sea sand-water ratio of 0.6:1 (for example, approximately 3 gm of sea sand and 5 gm of water), following which the mixture is poured into a heating tank 4; in Step C, the heating tank 4 is brought to the boiling point and a continuous boil is maintained for several minutes (approximately six minutes or more), the added water and boiling method removes surface-impregnated salt content and further decreases overall salinity; in Step D, at the completion of heating, the sand and water in the tank are sent via a rolling barrel-type screw conveyor to a filtration machine 5 for straining, the said filtration machine 5 filters the sea sand with hot water at its front section and a second fresh water wash S2 at its rear section, and then discharges the hot water and the post-wash fresh water into the first waste water pool 9; in Step E, the sea sand in the filtration machine 5 is conveyed into a second vibration sifter 6 and a third fresh water wash S3 for purging, following which the post-wash fresh water flows into a second waste water pool, the water in the pool is then pumped to the water tank of the first fresh water wash S1 to thereby recycle the waste water such that a major portion of the water at the first fresh water wash S1 is supplied from the second waste water pool, and the fully depurated sea sand is conveyed via a water wheel 7 to a sand dumping site.

To additionally reduce sea sand salt content relative to the said procedures, following the completion of the said Step D, the sea sand is transferred to a drying machine 8 for a desiccating operation, wherein the drying machine 8 is equipped with a conveyor belt and subjects the sea sand salt content to an evaporative process in which sea sand salt content is further reduced and, after this is completed, the sea sand is sent to the second vibration sifter 6 and the said Step E is carried out, wherein it is washed at the rear section and deposited at the sand dumping site.

In the experimental testing phase of the invention herein, test results indicated a 0.003% chlorine ion and 0.006% salt (NaCl) content, with the sea sand sourced from the seacoast of Pali Hsiang, Taipei Hsien, as detailed in the attached photocopied test measurements.

Utilizing the said method in the development of a sea sand desalination process culminated in a rapid and economical sea sand desalting process in which the quality of the treated sea sand complied with prevailing standards for construction- and civil engineering-use fine aggregate materials.

In summation of the foregoing section, since the sea sand desalination method of the invention herein is capable of economically and rapidly achieving its objectives and, furthermore, at a reliable level of quality, the present invention meets patent application requirements and is lawfully submitted in application thereof.

1. A sea sand desalination method, the procedures of which consist of the following steps:
A. Drawn sea sand is conveyed into a first vibration-type sifter machine (referred to hereafter as vibration sifter) and a first fresh water wash to purge coarse grains and foreign matter in the sea sand, with the post-wash waste water then flowing to a first waste water pool, and the coarse grains and foreign matter are discharged through pipes such that the resultant depurated sea sand is conveyed into a first sand trough.
B. A fixed quantity of sea sand in the said first sand trough is conveyed into a measuring tank, with the sea sand in the said measuring tank blended at a sea sand-water ratio of 1:2, following which the mixture is poured into a heating tank.
C. The said heating tank is brought to the boiling point and a continuous boil is maintained for several minutes (approximately six minutes at minimum).
D. At the completion of heating, the sand and water in the said tank are sent via a rolling barrel-type screw conveyor to a filtration machine for straining, the said filtration machine filters the sea sand with hot water at its front section and a second fresh water wash at its rear section, and then discharges the hot water and the post-wash fresh water into the said first waste water pool.
E. The sea sand in the said filtration machine is conveyed into a second vibration sifter and a third fresh water wash for purging, following which the post-wash waste water flows into a second waste water pool, the water in the pool is then pumped to the said first fresh water wash for recycling and re-use and the fully depurated sea sand is conveyed via a water wheel to a sand dumping site.

2. A sea sand desalination method based on the said procedures for further reducing the chlorine ion content in sea sand, wherein the steps of the method are:
a. Drawn sea sand is conveyed into said first vibration-type sifter machine (referred to hereafter as vibration sifter) and the said first fresh water wash to purge coarse grains and foreign matter in the sea sand, with the post-wash waste water then flowing to the said first waste water pool, and the coarse grains and foreign matter are discharged through pipes such that the resultant depurated sea sand is conveyed into the said first sand trough.
b. A fixed quantity of sea sand in the said first sand trough is conveyed into the said measuring tank, with the sea sand in the said measuring tank blended at a sea sand-water ratio of 1:2, following which the mixture is poured into the said heating tank.
c. The said heating tank is brought to the boiling point and a continuous boil is maintained for several minutes (approximately six minutes at minimum).
d. At the completion of heating, the sand and water in the said tank are sent via a rolling barrel-type screw conveyor to the said filtration machine for straining, the said filtration machine filters the sea sand with hot water at its front section and the said second fresh water wash at its rear section, and then discharges the hot water and the post-wash fresh water into the said first waste water pool.
e. The sea sand in the said filtration machine is transferred to a drying machine, where a desiccating operation is conducted, with the said desiccating operation further reducing the salt content of the sea sand through evaporation.
f. The sea sand in the said drying machine is sent to the said second vibration sifter and the said third fresh water wash for purging, following which the post-wash waste water flows into the said second waste water pool, the water in the pool is then pumped to the said first fresh water wash for recycling and re-use and the fully depurated sea sand is conveyed via the said water wheel to a sand dumping site.

3. As mentioned in claim 2 of the sea sand desalination method of the invention herein, the said drying machine is equipped with a conveyor belt to facilitate the said desiccating operation.
